(19) United States
(12) Patent Application Publication
(10) Pub. No.: US 2011/0125533 A1
(43) Pub. Date: May 26, 2011

(54) Remote Scribe-Assisted Health Care Record Management System and Method of Use of Same

(76) Inventors: Robert M. Budacki, Erie, PA (US); Shannon S. Gdaniec, Harrison City, PA (US)

(21) Appl. No.: 12/949,867

(22) Filed: Nov. 19, 2010

Related U.S. Application Data
(60) Provisional application No. 61/263,144, filed on Nov. 20, 2009.

(51) Int. Cl. G06Q 50/00; G06Q 10/00

(52) U.S. Cl. 705/3

(57) ABSTRACT

The invention disclosed herein describes a health care records management system and method of use that utilizes a scribe located in a remote location separate from an examination room. The remote location is electronically connected through a network to a monitor located within the examination room. A caregiver communicates auditorily with the scribe and directs the scribe to manipulate the patient's electronic medical record consistent with the examination in real-time. The caregiver verifies all changes and modifications to the patient's medical record during the examination and can further order tests, diagnostics, prescriptions and referrals electronically at the conclusion of the examination.

### CROSS-REFERENCE TO RELATED APPLICATIONS

The present application claims the benefit of U.S. Provisional Application No. 61/263,144 filed on Nov. 20, 2009, which is incorporated herein by reference.

### FEDERALLY SPONSORED RESEARCH

Not Applicable

### BACKGROUND

Today, medical records are no longer produced by a physician or other caregiver writing on paper. Medical records are mostly produced electronically and stored in databases at hospitals and physician offices alike. Current electronic medical record systems fail to satisfy the needs of modern medical practices due to the necessity of hands-on data entry by the physician or caregiver. In most situations the manipulation of software using a computer results in prolonged involvement of the physician in data management, data entry and the retrieval of patient records. This involvement reduces efficiency and increases the time a physician must take working on a patient's chart. This in turn decreases the number of patients attended by that physician on a given day. The invention disclosed herein contemplates the addition of a remote medical transcriber (referred to herein as the “scribe”) whose sole purpose is to manipulate a patient's electronic medical records at the direction of the physician or other health care provider in real-time. The scribe's involvement in the process also frees the physician or caregiver of many duties thereby allowing their focus to remain on the patient rather than data processing.

Scribes have historically been utilized both in paper and electronic record management being situated within the examination room with the physician and patient present. Examination room dimensions often restrict the location of the scribe within the room. The presence of clinical staff, the patient and the patient's family members along with the physician crowds the situation within the examination room. The scribe's presence becomes another complication. With the scribe in the examination room, there also exists awkwardness for the physician to view the monitor of the scribe's computer for overview of the chart note detail, review of results of studies, or to illustrate data to the patient. For the foregoing reasons, there is a need for a system and method of use whereby a remote scribe is used to manipulate and manage health care records.

### SUMMARY

The present invention is directed to a system and method of use satisfying the needs discussed in the Background section. The system comprises a physician or other health care professional situated in an examination room with a patient. The examination room is outfitted with a flat panel monitor connected to a network, and the physician or other health care provider is communicating to a scribe situated in a remote location via a voice communications device over a network or telephone system. The scribe is sitting at a computer connected to the facility's medical record database and network. The monitor in the examination room is connected through a network to the patient's electronic medical record. In various embodiments, the monitor described can be a desktop computer, laptop computer or tablet computer as well as a conventional monitor.

The physician or other health care professional goes about a normal examination with the patient and speaks directly to the scribe who inputs and modifies, at the health care professional's direction, changes to the patient's electronic medical record in real-time. The health care professional reviews the modifications made by the scribe for accuracy and completeness as those changes are made to the electronic medical record as shown on the monitor in the examination room.

Upon completion of the examination, as the patient's electronic medical record is up to date and complete, laboratory tests, diagnostic tests, prescriptions and other referrals can be performed electronically, or can be printed out and handed to the patient prior to the patient leaving the examination room.

The system and method described herein allows the patient's medical record to be completed in real-time, but, unlike current practices, does not require a physician or other health care professional to manually input any data. This system also deletes the need for a physician or other health care professional to orally dictate changes to a patient's medical record after an examination as such changes have already been done during the examination itself.

### BRIEF DESCRIPTION OF THE DRAWINGS

These and other features, aspects and advantages of the present invention will become better understood with regard to the following description, appended claims, and accompanying drawings where:

FIG. 1 is a schematic overview of the preferred embodiment of the disclosed invention.

FIG. 2 is a schematic overview of an alternative embodiment of the disclosed invention.

FIG. 3 is a flowchart of the preferred embodiment of the disclosed invention.

### DESCRIPTION

The present invention relates to a health care record management system which utilizes a remote scribe to manipulate a patient's medical record in real-time during an examination and a method of use of the same. A physician or other health care professional such as a physician assistant, nurse or nurse practitioner (collectively referred to herein as the “caregiver”) is situated in an examination room with a patient. Prior to entering the examination room, the caregiver can review the patient's electronic medical record at a terminal outside the examination room.

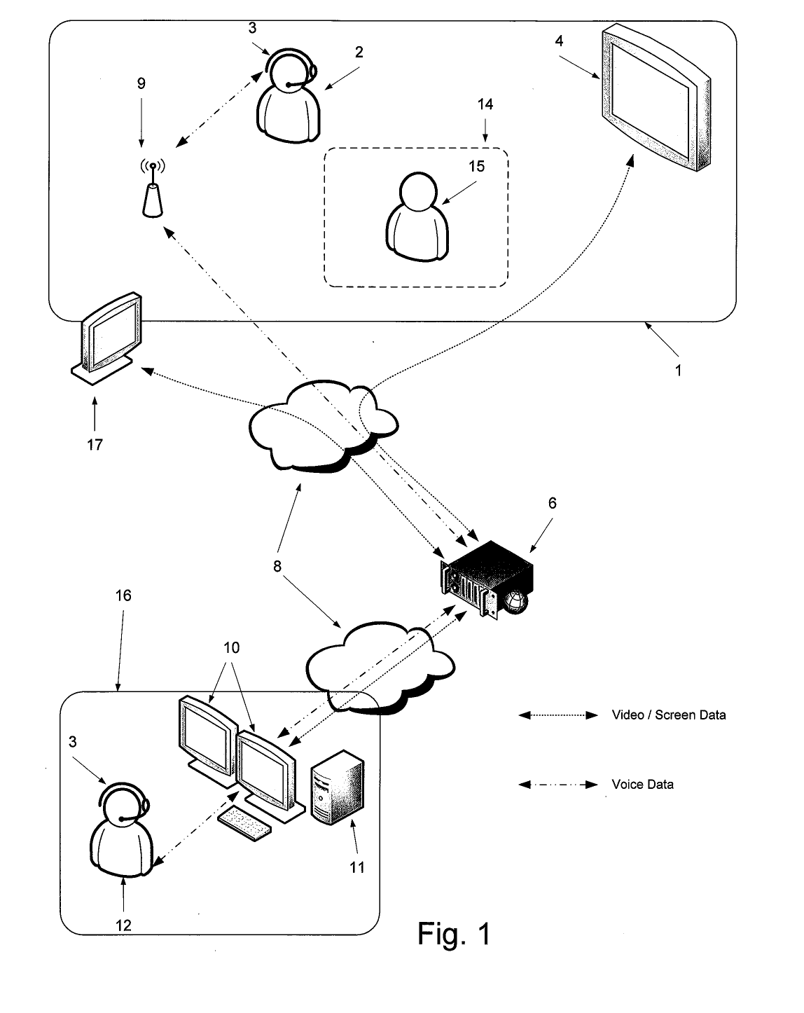

As set forth in FIG. 1, one of the embodiments of the within invention utilizes a large flat screen monitor 4 mounted behind the exam chair 14 in the examination room 1 in easy view of the caregiver 2. The caregiver 2 is outfitted with a voice device 3 which transmits and receives voice through a voice receiver 9. The voice receiver 9 is connected via a network 8 and a voice/video media matrix 6 to a scribe 12 for oral communication purposes. A network as utilized in the within invention includes a means of interconnecting computers, devices and similar peripherals as known throughout the art.

A patient 15 on the exam chair 14 can also view the monitor 4 when the caregiver 2 illustrates points made during the examination. Of course, the patient 15 can also be situated on an examination table or other similar device rather than a chair within the examination room 1. The scribe 12, in a remote office location 16, has a personal computer 11 connected to a network 8 which is used to manipulate the electronic medical record software for the caregiver 2. The scribe's computer 11 is connected via the network 8 and a voice/video media matrix 6 to the voice receiver 9.

The scribe 12 utilizes two monitors 10 each connected to the personal computer 11. One monitor display 10 allows viewing and manipulation of the patient record keeping software while the second monitor display 10 permits control of the output of the signal from the personal computer 11. It is also contemplated that a single monitor be used or more than two monitors as described in the within embodiment depending on varying factors. The record keeping application viewed on the personal computer monitor 10 is forwarded to the monitor 4 by sending the data signal through a network 8, to a voice/video media matrix 6, through a network 8 to said monitor 4 within the examination room 1.

Multiple scribes share the electronic medical record application stored on the network 8. Moreover, each scribe has the ability, through the voice/video media matrix 6, to display any patient's electronic medical record on any monitor as directed by the caregiver 2. All transmissions made in the within invention are done in compliance with the Health Insurance Portability and Accountability Act of 1996 (also known as “HIPAA”).

A separate software application controls the signal leaving the scribes' computer 11 and its input to and output from voice/video media matrix 6. The application software of the matrix 6 permits the video to be directed as output from the personal computer 11 to monitors 4 located in any exam room 1 used by the caregiver 2. A caregiver 2 working between any number of rooms can view the signal in any room as the signal is controlled to that room only. The caregiver 2, and the scribe 12 communicate orally through voice devices 3 which send signals through a receiver 9 or the scribe's computer 11.

The caregiver 2 verbally indicates and verifies the patient's 15 identity to the scribe 12 before entering the examination room 1. This can be done at a monitor 17 located outside of the examination room 1. At the monitor 17, the caregiver 2 can review the patient's 15 electronic medical record prior to the subsequent examination. The scribe 12 double-checks the patient's identity with the caregiver's 2 electronic schedule.

During the examination, the scribe 12 manipulates the electronic medical record application to create, modify, manipulate and/or navigate the electronic patient record. The electronic medical record application has a pre-designed template allowing selection of many repetitive and routine entries. The caregiver 2 has the opportunity to review and “free form” any text to any portion of the record. The scribe 12 takes the free text direction from the caregiver 2 and accordingly modifies the electronic patient record. The caregiver 2 in real-time communication with the scribe 12 can request retrieval of past records, lab reports and can view radiology results on media provided by outside facilities all while continuing to attend to the patient 15. Various software applications permit prescriptions to be electronically sent at the caregiver's 2 order. The examination chart note can be forwarded electronically to another physician or referral source before the patient even exits the office. Also, at the caregiver's 2 request, the scribe 12 may search assistive treatment information from reliable internet resources for patient education and information sharing with referral sources. All of these tasks can be accomplished without the hands on involvement of the caregiver 2.

The smaller monitor 17 situated outside the examination room for caregiver 2 review of patient records before entering the room can also assist in monitoring the caregiver's 2 appointment schedule. The smaller monitor provides those caregivers not desiring to review the patient record in the presence of the patient the opportunity to do so. The signal to the small monitor is controlled by the scribe 12, as is the record review through the receiver 5. The scribe can utilize any monitor to display daily patient telephone contacts formulated into electronic mail messages attached to the patient record for caregiver review. The monitor can further be used to review outside reports and comments in the patient record as needed.

In a separate embodiment, the scribe 12 can use a corded headset with microphone and the caregiver can utilize a wireless ear-level worn headset with microphone in one ear each connected to telephones located within their respective rooms, 1, 16. This will allow the caregiver 2 and scriber 12 to communicate orally through a telephone system in a more conventional fashion rather than through the network as set forth in FIG. 1.

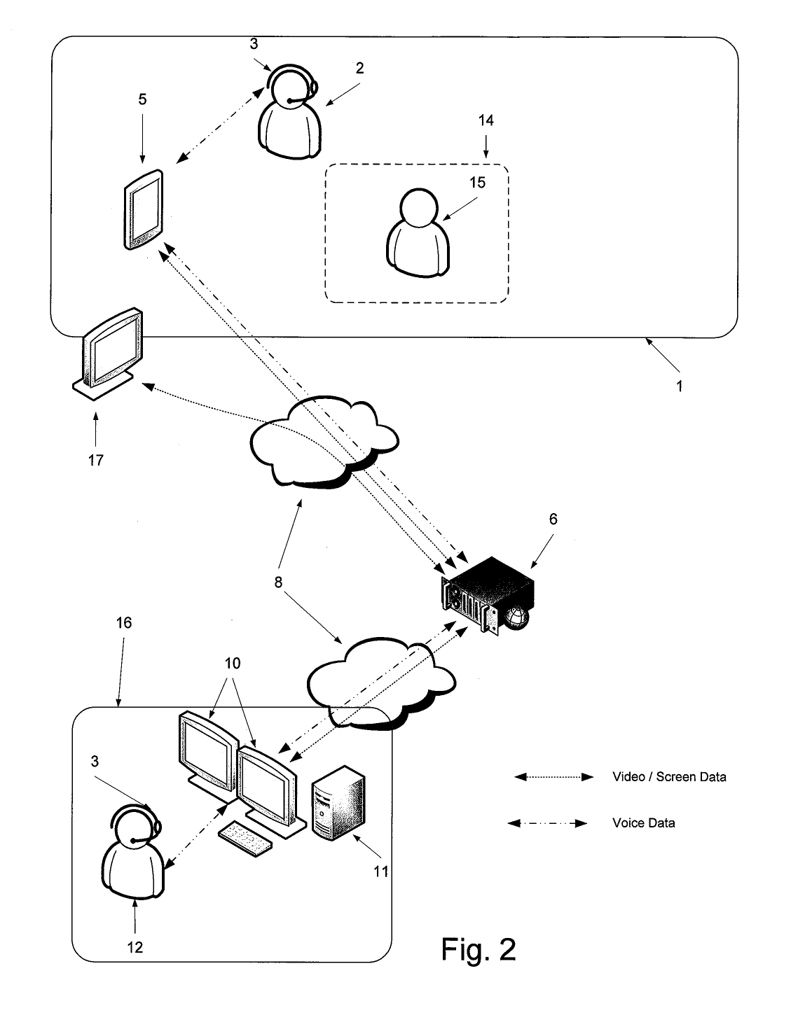

In another embodiment of the within invention as illustrated in FIG. 2, the monitor in the examination room and the receiver have been replaced with a single piece of equipment that serves as both a monitor and a receiver, such as a tablet computer 5. The tablet computer 5 has the ability to communicate with the caregiver's voice device 3 and send the voice data through a network 8 to the voice/video media matrix 6, through a network 8 and to the scribe's computer 11 so that the scribe 12 can communicate via the scribe's voice device 3 with the caregiver 2. It is contemplated that the tablet computer 5 in FIG. 2 could, in the alternative, be a laptop computer, a desktop computer, a television monitor with a computer embedded or other technology that contain a monitor component and a voice data send and receive component.

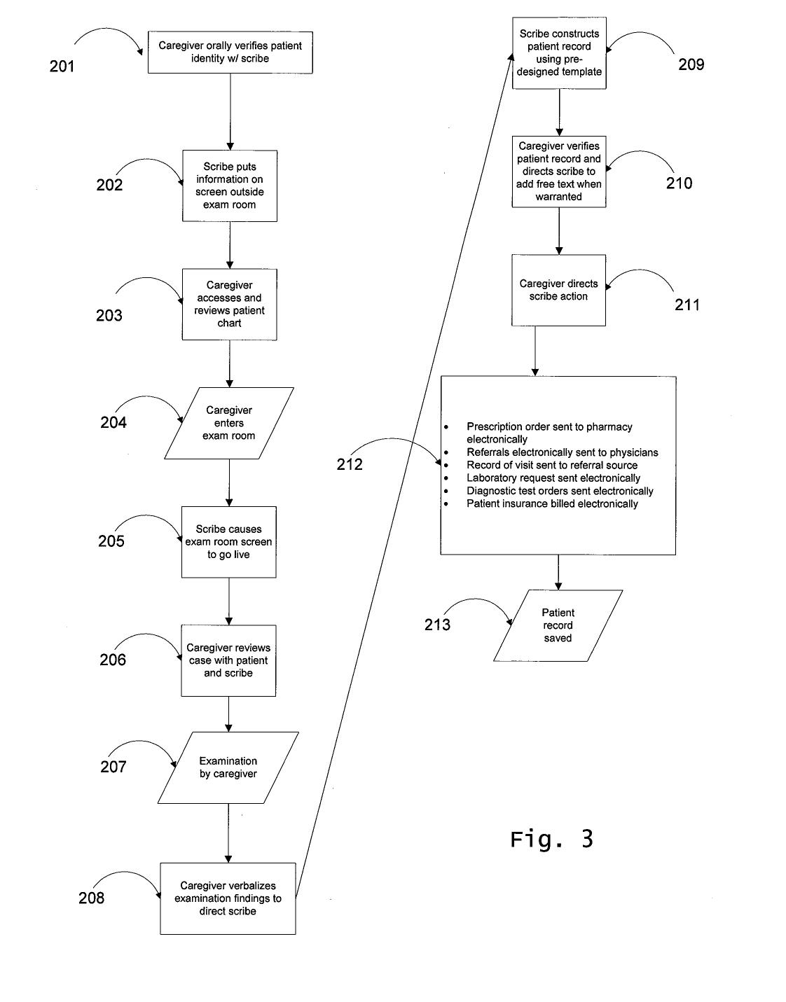

In the preferred embodiment of the within invention, as set forth in FIG. 3, the method of use of the scribe assisted health care record management system is disclosed. The caregiver verifies the patient's identity orally with the scribe 201. Next, the scribe displays the patient's information on the monitor outside of the examination room 202. At said monitor, the caregiver can assess and review the patient's electronic medical record 203.

Once the caregiver has reviewed the patient's chart and is ready to begin the examination, the caregiver enters the examination room 204. The scribe then causes the monitor in the examination room to go live 205 as the caregiver enters the room. The caregiver can then review the case with the patient and the scribe 206 speaking directly to the patient and speaking with the scribe through the network voice data system. The caregiver then performs the examination of the patient 207 and makes findings.

The caregiver will then verbalize the examination's findings to the scribe through the network voice data system to direct the scribe 208 to make the requisite changes to the patient's electronic medical record. At the caregiver's direction, the scribe can then construct modifications to the patient's electronic medical record utilizing pre-designed templates 209 in the computers system's software. The caregiver can then verify the modifications to the patient's electronic medical record by viewing the monitor in the examination room and further direct the scribe to add free text when necessary 210.

At the conclusion of the examination encounter with the patient, the caregiver can direct the scribe to perform additional actions 211. At the direction of the caregiver, the scribe can perform a number of actions electronically when appropriate, including but not limited to:
sending prescriptions to the patient's pharmacy,
transmitting referrals to other caregivers,
transmitting a record of the patient's visit to a referral source,
transmitting requests for laboratory tests to be performed on the patient,
transmitting requests for diagnostic tests to be performed on the patient, and
transmitting bills to a patient's insurance company for payment. 212

Once the requisite actions are completed, the scribe then saves the patient's electronic medical record 213 to the medical record application. All of the actions performed at 212 can also be done by simply printing out a paper copy and transmission accomplished by physically sending the paper by mail or taking it in person.

From the descriptions above, a number of advantages of the methods become evident:
1. An easy, efficient and cost-effective way to manipulate, interpret and modify an electronic patient healthcare record without a caregiver having to enter information manually into a computer system,
2. Elimination of the need to pass a notebook computer between a scribe and caregiver or to have the caregiver leave the patient's side to view a desk top monitor,
3. Reduction of caregiver time to dictate changes to a patient's electronic medical record after an examination encounter with a patient, and
4. A second check in the caregiver-dictation to transcriptionist system because the caregiver is checking the items being typed or modified in real time to assure accuracy and completeness.

While the description above refers to particular embodiments of the present invention, it will be understood by those skilled in the art that many modifications may be made and equivalents may be substituted without departing from the spirit thereof. The accompanying claims are intended to cover such modifications as would fall within the true scope and spirit of the present invention. The disclosed embodiments are therefore to be considered as illustrative and not as restrictive. The scope of the invention is defined by the appended claims.

We claim:

1. A remote scribe-assisted health care record management system, said system comprising:
(a) an examination room with means for viewing a patient's electronic medical record;
(b) a remote location with means for manipulating a patient's electronic medical record;
(c) electronic transmission means between said examination room and said remote location; and,
(d) telephonic means for oral communication between said examination room and said remote location.

2. A remote scribe-assisted health care record management system, said system comprising:
(a) a remote computer connected to a network with software means to connect to a database;
(b) said remote computer connected to a network;
(c) an examination room monitor connected a network;
(d) telephonic means near or adjacent to said examination room connected to telephonic means near or adjacent to said remote location; and,
(e) means to manipulate the data in said database.

3. The system of claim 1 where said means for viewing a patient's electronic medical record and said telephonic means for oral communication are achieved utilizing a single device.

4. A method of utilizing a remote scribe-assisted health care record management system, said method comprising:
(a) displaying of a patient's electronic medical record on a monitor by a scribe located in a remote location;
(b) verifying a patient's information on said monitor by a caregiver;
(c) examining a patient by a caregiver in an examination room;
(d) directing a scribe in a remote location to modify a patient's electronic medical record consistent with said examination;
(e) verifying changes to a patient's electronic medical record; and,
(f) saving the changes to the patient's electronic medical record.

5. The method of claim 4, further comprising electronically transmitting a patient's orders to a service provider, said orders chosen from the group consisting of diagnostic tests, laboratory tests, prescriptions, and health care provider referrals.

6. The method of claim 4, further comprising printing out a patient's orders directed at a service provider, said orders chosen from the group consisting of diagnostic tests, laboratory tests, prescriptions, and health care provider referrals.

7. The method of claim 4, further comprising electronically transmitting a patient's electronic medical record to a referral source or other health care provider.

8. The method of claim 4, further comprising printing out a patient's electronic medical record.
